(19) United States
(12) Patent Application Publication
(10) Pub. No.: US 2007/0295761 A1
(43) Pub. Date: Dec. 27, 2007

(54) DEVICE FOR POURING LIQUID IN A CONTAINER

(75) Inventor: Danny Simons, Paradise Waters (AU)

Correspondence Address: KIRTON AND MCCONKIE, 60 EAST SOUTH TEMPLE,, SUITE 1800, SALT LAKE CITY, UT, 84111, US

(73) Assignee: ARGYLE WINE TOOLS PTY LTD, Paradise Waters (AU)

(21) Appl. No.: 11/548,467

(22) Filed: Oct. 11, 2006

(30) Foreign Application Priority Data
Oct. 7, 2005 (AU) 2005905530

(51) Int. Cl. B67D 3/00

(52) U.S. Cl. 222/479

(57) ABSTRACT

A device for pouring liquid from a container comprising an aeration means with a downwardly extending tube having an upper section and a lower section angled with respect to the upper section.

### BACKGROUND OF THE INVENTION

The present invention relates to devices which attach to containers such as cartons or bottles. In a particular application the invention relates to a wine pourer device.

### FIELD OF THE INVENTION

A wine pourer device is disclosed in the applicant's co-pending PCT application no. PCT/AU2005/001046.

In FIGS. 8 and 9 of the above application a wine pourer device is disclosed incorporating an aerator. This aerator consists of a circular disk with a series of apertures therethrough and a downwardly directed central spigot with a passage therethrough. The spigot fits into a tube extending downwardly from the device and when the device is attached to a bottle extends through the neck of the bottle to the interior. When the bottle is tilted, this enables air flow through the passage in the spigot and through the tube which is attached thereto. Air is also able to pass through the holes as liquid such as wine is poured out through the holes.

The tube which is connected to the spigot would be long and vertically oriented. This however presents a problem with packaging as a long tube or straw in combination with the pourer device can lead to a doubling in the cost of packaging. In addition the long straw does not always provide enough aeration to enable wine to be effectively poured from a wine bottle. This is because if the air bubble in a bottle of wine does not reach the end of the bottle because the bottle is not fully inverted, air passing through the tube does not reach the air bubble.

### SUMMARY OF THE INVENTION

According to one aspect of the present invention there is provided a breather component for a pourer device for bottles, cartons or other fluid containers comprising a conduit with an upper section and a lower section angled with respect to the upper section.

According to another aspect of the present invention there is provided a device for pouring liquid from a container comprising an aeration means with a downwardly extending tube having an upper section and lower section angled with respect to the upper section.

Preferably the device includes a pouring lip.

It is preferred that the lower section of the tube is bent upwardly with respect to the lip of the pourer.

It is preferred that the lip of the pourer is located on one side of the device and the lower section is angled to the other side of the device.

The tube may comprise a straw.

Preferably the tube is connected to a spigot of the device, which has a passage therethrough.

According to an alternative embodiment the tube fits into a hole formed in the device.

Preferably the tube fits into a central opening or over a central opening in the device.

It is preferred that the device includes a plurality of openings through which liquid is poured when the device is attached to a container.

Preferably the holes assist with providing a turbulent flow of liquid therethrough and over the lip of the pourer.

It is preferred that the device when attached to a container (by screw-thread or other means) forms a seal with the neck of the container.

The lower section may be angled at approximately 135° with respect to the upper section.

The upper section may comprise a first conduit.

The lower section may comprise a second conduit.

The device may include a connector which connects the first and second conduits.

The connector may comprise an upper portion and a lower portion.

The upper portion may fit inside the lower end of the first conduit.

The lower portion preferably fits inside the upper end of the second conduit.

According to an alternative embodiment the upper portion fits over the lower end of the first conduit.

According to an alternative embodiment the lower end fits over the end of the second conduit.

Preferably the connector comprises an elbow member with a passage therethrough.

The upper portion may be axially out of alignment with the lower portion.

The upper portion may comprise a tubular spigot.

The lower portion may comprise a tubular spigot.

The upper portion may be tilted at between 110° and 170°.

The lower section may extend into the exterior of the bottle beyond the neck.

Preferably the connector, first conduit and second conduit are removably connected together.

The connector lower portion may include an axially extending slot in its peripheral surface. A similar slot may be provided in the upper portion.

The connector may comprise an elbow portion between the upper and lower portions.

The elbow portion may include a bulbous hollow section.

It is preferred that the angled lower section with respect to the upper section breaks the airlock within a bottle earlier than a conventional tube because it isn't as long. By breaking the airlock earlier, there is isn't as much pressure built up as when a full length tube is utilised.

### BRIEF DESCRIPTION OF THE DRAWINGS

A preferred embodiment of the present invention will now be described by way of example only with reference to the accompanying drawing in which:

FIG. 1 shows a front view of a wine pourer device in accordance with the present invention; and

FIG. 2 shows a side view of the wine pourer device shown in FIG. 1.

### DETAILED DESCRIPTION OF THE DRAWINGS

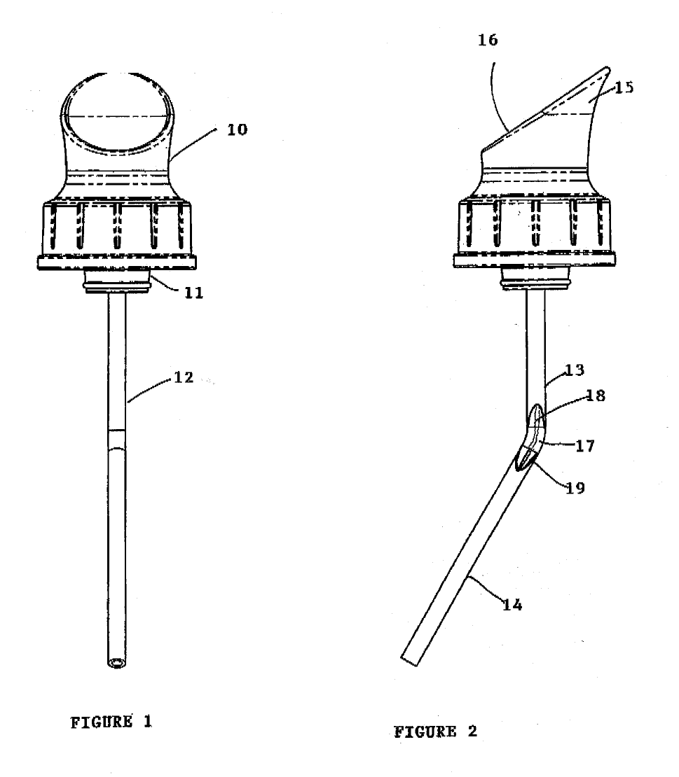

The wine pourer device shown in FIGS. 1 and 2 consists of a screw-on pourer 10 of a similar design to the pourer shown in FIG. 8 of the co-pending application previously referred to. A stopper 11 extends from the bottom of the pourer 10 and has a central downwardly extending spigot (not shown).

A tube 12 fits over the spigot and extends downwardly from the pourer 10.

As shown in FIG. 2 the tube 12 consists of an upper section 13 and a lower section 14 which is angled at approximately 135° with respect to the upper section 13. In addition the lower section 14 is angled in the opposite direction to the side of the pourer 10 on which the lip 15 of the mouth 16 is located.

An elbow section 17 is located between the upper section 13 and lower section 14 of the tube 12.

The elbow section 17 consists of an upper tubular spigot 18 and a lower tubular spigot 19.

To provide structural integrity and ease of packaging of the tube 12 it is made in three separate sections consisting of the upper tube 13, elbow connector 17 and lower tube 14. The upper spigot 18 fits into the lower end of tube 13 and the lower spigot 19 fits into the upper end of tube 14. The lower spigot 19 may also be provided with a lateral slot along its axial length. This provides a number of advantages including ease of manufacturing and an easy means of cleaning any blockages in both the upper and lower parts of the elbow connector 17.

The elbow connector 17 also includes an enlarged elbow portion in the form of a peripheral flange. This provides structural integrity to the overall elbow connector.

The angle of the elbow connector may also be changed to suit different sized bottles. Thus a wider neck bottle would require an elbow connector with a smaller angle between the upper and lower conduits 13 and 14.

The elbow connector preferably has a passage extending all the way therethrough. The passage may be in the form of a lateral slot which is closed on its open side as a result of the upper and lower conduits being placed over each end of the connector.

The elbow section has a larger width or diameter than the upper and lower spigots 18 and 19 and therefore provides a buffer against which the upper and lower tubes 13 and 14 can abut.

In use the upper tube 13, lower tube 14 and elbow connector 17 may be made separately and sold in packaging as a kit of parts which can be connected together. When they are connected together it is preferred that the lower conduit 14 and thus the lower spigot 19 is angled in the opposite direction to the side of the pourer on which the lip 15 is located. The pourer can then be screwed onto the neck of a screw threaded bottle and the length of the lower tube 14 can be made long enough so that it is able to touch the inner edge of the bottle.

When the bottle is then tilted to pour out the liquid contents the lower tube 14 will be tilted upwardly as the bottle is moved to a horizontal orientation with lip 15 facing downwardly. As this occurs the air bubble in the bottle will pass along the upper inside edge of the bottle and preferably will be contacted by the lower end of lower tube 14. As a result air passing through the central spigot through tube 13, connector 17 and lower tube 14 will communicate with the air bubble providing atmospheric pressure behind the wine in the bottle and helping to force it out through the hole surrounding the central spigot of the pourer 10. It is preferred that wine is then able to be poured at a generally consistent flow rate without the discontinuous surges which occur in a typical bottle of liquid which is turned upside down.

The combined length of the upper tube 13, elbow connector 17 and lower tube 14 may be significantly less than the length of a vertical tube which achieves the same purpose of allowing atmospheric pressure to force out the liquid contents when the bottle is inverted.

According to one embodiment of the invention the elbow connector has a degree of resilience which allows the angle between the upper and lower spigots to be varied, preferably by up to 5%.

Another advantage of having the lower tube made in separate components is the ability of the tube to be cleaned and used over and over again.

It is to be understood that, if any prior art publication is referred to herein, such reference does not constitute an admission that the publication forms a part of the common general knowledge in the art, in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A device for pouring liquid from a container comprising an aeration means with a downwardly extending tube having an upper section and a lower section angled with respect to the upper section.

2. The device as claimed in claim 1 including a pouring lip.

3. The device as claimed in claim 1 wherein the lower section of the tube is bent with respect to the lip of the pourer.

4. The device as claimed in claim 1 wherein the tube is connected to a spigot of the device which has a passage therethrough.

5. The device as claimed in claim 1 wherein the upper section comprises a first conduit and the lower section comprises a second conduit connected to the first conduit by a connector.

6. The device as claimed in claim 1 including a connector with an upper portion which connects to the upper section and a lower portion which connects to the lower section.

7. The device as claimed in claim 6 wherein the upper section comprises a first conduit, the lower section comprises a second conduit and the connector comprises an elbow member with a passage therethrough and the upper portion fits inside the lower end of the first conduit and the lower portion fits inside the upper end of the second conduit.

8. The device as claimed in claim 7 wherein the upper portion is tilted at between 110° and 170° with respect to the lower portion.

9. The device as claimed in claim 6 wherein the connector lower portion includes an axially extending slot in its peripheral surface.

10. The device as claimed in claim 6 wherein the connector upper portion includes an axially extending slot in its peripheral surface.

11. The device as claimed in claim 6 wherein the elbow portion includes a bulbous hollow section.

12. The device as claimed in claim 11 wherein the device comprises a plurality of openings located in a wall of the device around a central passage to which the tube is connected, the openings being configured to provide a turbulent flow of liquid therethrough when the device is in use.

13. The device as claimed in claim 12 including an attachment means whereby the device can be screwed onto a bottle so as to form a seal with a neck of the bottle.

14. The device as claimed in claim 12 wherein the upper section connector and lower section are removable attachable together.

15. A breather component for a pourer device for bottles, cartons or other fluid containers comprising a conduit with an upper section and a lower section angled with respect to the upper section.
